(19) United States
(12) Patent Application Publication
(10) Pub. No.: US 2002/0147689 A1
(43) Pub. Date: Oct. 10, 2002

(54) Method for providing copies of electronic files

(76) Inventor: Douglas A. Falkner, Hendersen, NC (US)

Correspondence Address: Ladas & Parry, 26 West 61st Street, New York, NY, 10023, US

(21) Appl. No.: 10/107,031

(22) Filed: Mar. 27, 2002

Related U.S. Application Data
(60) Provisional application No. 60/281,310, filed on Apr. 4, 2001.

(51) Int. Cl. G06F 17/60

(52) U.S. Cl. 705/52

(57) ABSTRACT

A method for a service provider to provide copies to a user of electronic files establishes a user's credit account for the service provider to receive advance payments from the user, accepts payments into the credit account from the user, and provides a first catalogue of payment electronic files, a second catalogue of tipping electronic files and a third catalogue of free electronic files, to which access is to be provided. When a request is received from the user for one of the electronic files, it is confirmed that the user's credit account is in credit by a predetermined minimum amount. Where the requested electronic file is in the first catalogue, it then accepts transfer of monetary value from the user's credit account to an account of the service provider and provides a copy of the requested file. Where the requested electronic file is in the second catalogue, it then invites the user to transfer a discretionary monetary value from the user's credit account to the service provider's account and provides a copy of the requested electronic file. And where the requested electronic file is in the third catalogue, it then provides a copy of the requested electronic file and transfers a proportion of the transferred monetary value, if any, to a respective copyright holder, if any, of the requested electronic file.

### BACKGROUND OF THE INVENTION

1) Field of the Invention

This invention relates to a method for providing copies of electronic files.

2) Description of the Related Art

The downloading of, for example, music files in MP3 format, over the Internet either on payment of a subscription or for no charge is well known. For example, Napster Inc. have maintained catalogues online to allow users to exchange MP3 files between themselves. Subsequently, Napster have proposed a system for providing downloadable files for a subscription payment, whereby a basic service charge allows members a limited number of file transfers, or song exchanges, each month, and a premium service which allows an unlimited number of downloads of songs. A proportion of the subscription fees is passed to copyright holders of the songs. Such subscription services have the disadvantage that users must pay their monthly subscription irrespective of whether or not they wish to download a significant number, or any, songs in a particular month.

A system is known from Amazon.com which uses a system of collecting tips in which individual musicians may make electronic files of their songs available on a central Internet website with tip boxes being automatically available on all the song download pages of the website. Alternatively, the musician can collect voluntary payments and sell digital music from their own website. There are no registration or monthly fees, the tips being charged directly to the user's credit card. However, downloads are, in principal, free and tipping is always optional. No means are provided to avoid abuse of the system by a user consistently downloading files without tipping. The collected tips are passed to the musicians with 30% of the total payment deducted by Amazon.com as a service charge. This is basically an exposure vehicle for unknown musicians. Alternatively, the system is used as a sales promotion by music publishers to promote the sales of compact discs (CDs). There is no automatic mechanism for the payment of copyright holders of the downloaded files.

The payment of voluntary payments or tips is also known from TipJar Internet Treasury, run by TipJar, Kansas City, Mo., USA, whereby a user with a web browser and email address can give money to another user with an email address. There is a service charge for both putting money in and taking small amounts of money out of the user's “Tipjar” account. A similar method of making voluntary payments has been disclosed in the Tipster Protocol, which allows users to make payments for downloaded files based on information embedded in the files themselves. This necessarily requires modification of the files when they are loaded onto a server for subsequent downloading.

### SUMMARY OF THE INVENTION

It is an object of the present invention to at least ameliorate the difficulties in the present methods of downloading electronic files.

According to a first embodiment of the invention, there is provided a method for a service provider to provide copies to a user of electronic files, the method comprising the steps of: a) establishing a user's credit account for the service provider to receive advance payments from the user; b) accepting payments into the credit account from the user; c) providing a first catalogue of payment electronic files, a second catalogue of tipping electronic files and a third catalogue of free electronic files, to which access is to be provided; d) receiving a request from the user for one of said payment electronic files, tipping electronic files and free electronic files; e) confirming that the user's credit account is in credit by a predetermined minimum amount; f) where the requested electronic file is included in the first catalogue, accepting transfer of monetary value from the user's credit account to an account of the service provider and providing a copy of the requested file, where the requested file is included in the second catalogue inviting the user to transfer a discretionary monetary value from the user's credit account to the service provider's account and providing a copy of the requested electronic file, and where the electronic file is included in the third catalogue providing a copy of the requested electronic file; and g) transferring a proportion of the transferred monetary value, if any, to a respective copyright holder, if any, of the requested electronic file.

Conveniently, where the requested electronic file is in the second catalogue, the step of inviting the user to transfer discretionary monetary value includes the further step, where the user does not transfer a discretionary monetary value, of maintaining a record of the user's access to the electronic file without paying a discretionary monetary value so that the user may subsequently be given at least one further opportunity to transfer a discretionary monetary value corresponding to the download of the said electronic file.

Preferably, where the user does not transfer monetary value on downloading the file nor in response to the at least one further opportunity, in relation to a predetermined number, or percentage, of electronic files downloaded, the user's access to electronic files in the second and third catalogues is suspended or otherwise restricted.

Advantageously, the user is provided with a downloaded copy of the requested file in a protected form which limits the further copying of the downloaded copy of the file to none or a predetermined number of further copies.

Conveniently, step b) of accepting payments includes accepting a voucher number in lieu of payment to increase the credit held in the credit account.

Advantageously, the voucher is distributed with a product as a sales incentive for that product.

Conveniently, the voucher permits a predetermined number of MP3 audio files to be copied.

Alternatively, the voucher permits a predetermined number of minutes of MP3 audio files to be downloaded.

Advantageously, where at least some of the electronic files are arranged in album sets, there is a predetermined limit on the number of files that can be copied from one album set.

Conveniently, where the requested file is included in the second catalogue, the step of inviting the user to transfer discretionary monetary value comprises requesting the user to transfer a discretionary monetary value between a predetermined minimum and a predetermined maximum amount.

Preferably, at least some of the steps of the method are carried out over a telecommunications network.

Advantageously, the telecommunications network is the Internet.

Conveniently, the user's credit account is maintained on a first website and the electronic files are maintained on one or more other websites.

Advantageously, the first further invitation to contribute discretionary monetary values is sent by email a first plurality of days after the file is copied and a second further invitation to transfer discretionary monetary values is sent by email a second plurality of days after the file is copied.

Preferably, a history file is maintained of records of copies of files relating to the second catalogue which are provided to a user and by reference to which further access to the method is suspended or restricted for the user when a percentage or number of copies downloaded to the user for which payment is paid falls below a predetermined percentage or number respectively.

Advantageously, where the electronic file is included in the third catalogue, the method includes the further step of accepting a voluntary transfer of monetary value from the user's credit account to the service provider's account.

Advantageously, the electronic files are one or more of an audio file, a video file, a video game, a picture file and a text file.

Conveniently, where the electronic file is included in the first catalogue, the monetary value transferred from the user's credit account is selectable by the user between a predetermined minimum amount and a predetermined maximum amount.

According to another embodiment of the invention, there is provided a method for a service provider to provide copies to a user of electronic files, the method comprising the steps of: a) establishing a user's credit account for the service provider to receive advance payments from the user; b) accepting at least one unit of credit into the credit account from the user; c) providing a catalogue of electronic files to which access is to be provided and making the catalogue searchable by the user; d) receiving a request from the user for one of said electronic files; e) confirming that the user's credit account is in credit by a predetermined minimum amount; f) transferring credit from the user's credit account to an account of the service provider, making a payment of a portion of the transferred credit to a copyright holder of the file, if any, and providing a copy of the requested file.

Advantageously, the electronic file is a digital music file or a digital video file.

Conveniently, the unit of credit represents an allowed predetermined playing time.

Alternatively, the unit of credit represents an allowed predetermined number of downloads of electronic files.

Conveniently, step f) includes the additional step of allowing the user to sample the electronic file before deciding whether to download a copy of the file.

Preferably, step b) of accepting at least one unit of credit includes the step of accepting a voucher number representing at least one unit of credit.

Preferably, step f) includes informing the user of the units of credit remaining in the user's credit account.

Advantageously, the electronic files include digital music data, video data and text data.

Conveniently, step f) includes providing a copy of the file encoded in such a manner to ensure that the copied file can be further copied no, or only a predetermined number of, times.

Conveniently, step f) includes transferring further credit units from the user's credit account into an account of the service provider to permit additional copies of a file to be made.

Advantageously, step d) comprises receiving a request from a user located in a retail establishment and step f) comprises providing a copy of the requested file to a terminal in the retail establishment for copying the electronic file onto a removable storage medium.

### BRIEF DESCRIPTION OF THE DRAWINGS

Embodiments of the invention will now be described by way of example with reference to the accompanying drawings in which:

FIG. 1 shows a flowchart of a first embodiment of the invention; and

FIG. 2 shows a flowchart of a second embodiment of the invention.

In the figures like reference numerals denote like parts.

### DESCRIPTION OF THE PREFERRED EMBODIMENTS

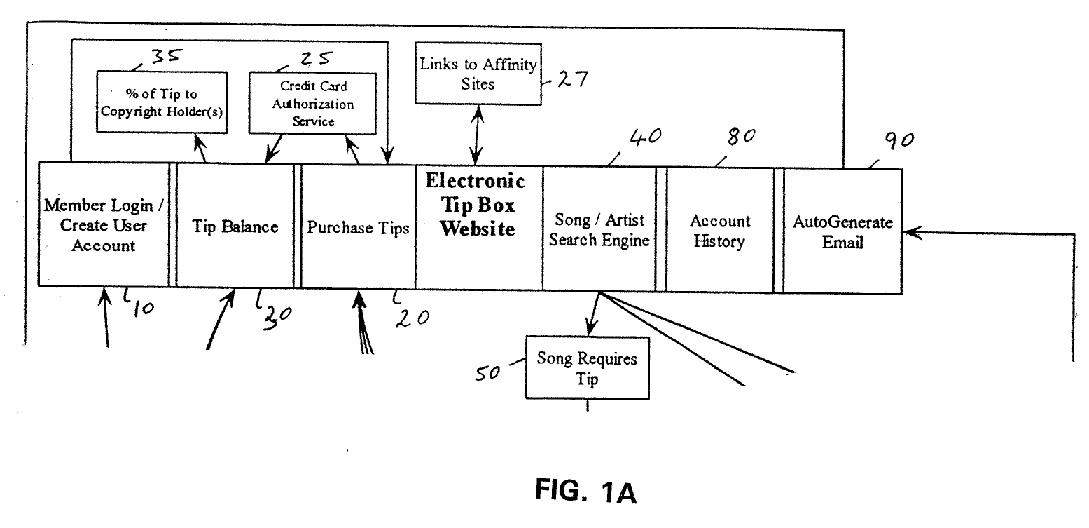

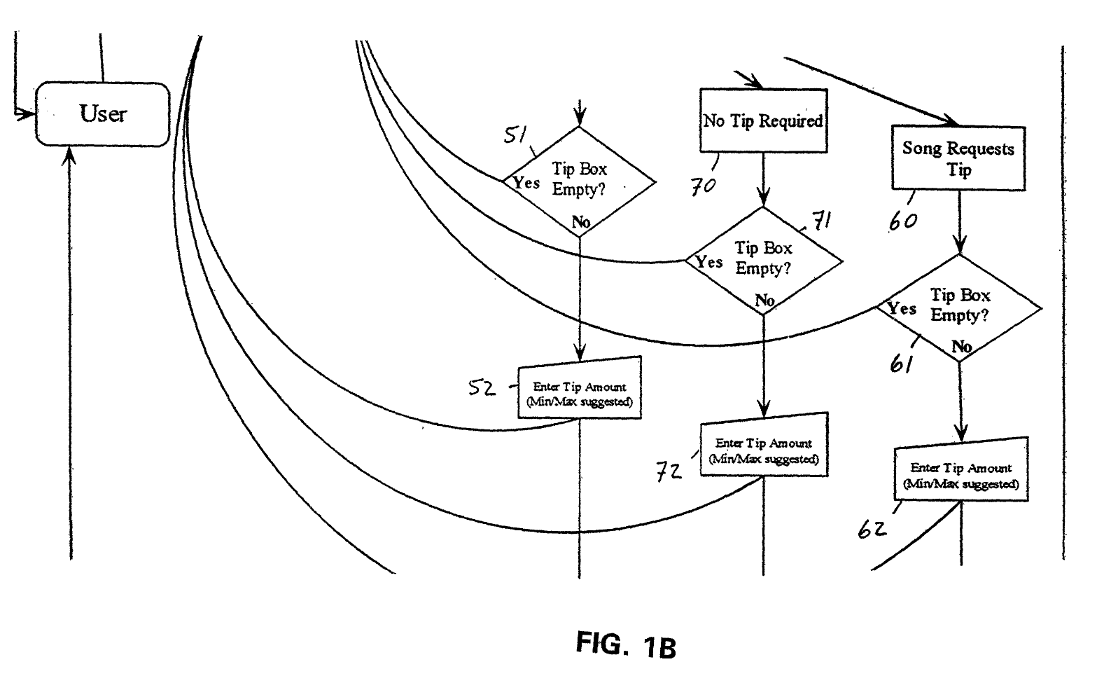

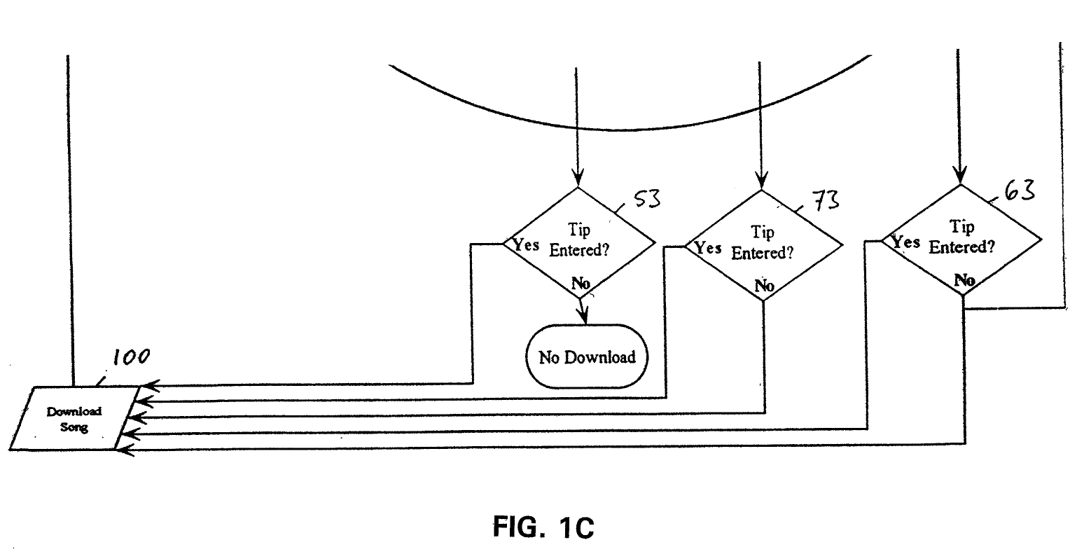

Referring to FIG. 1, a user logs into, step 10, an electronic tip box website. If the user is a new user then a user account is created in a known manner and the user is assigned a member login name and password for subsequent use. If the user is an existing user then the user is invited to enter their member login and password.

Having entered their member login and password, the user is invited, step 20, to purchase tips, that is, to make a payment to establish or increase a monetary balance in a tipping account assigned to the user. If the user proceeds to make a payment then the user's tipping account is consequentially updated, step 30. Where the user makes payment by means of a credit card, known credit card authorisation procedures are carried out, step 25, with a credit card authorisation service before the balance in the tipping account is amended. In addition to credit being added to the tipping account by means of payments, new credits may also be acquired by means of vouchers or transactions on associated affinity websites and the user's credit balance updated, step 27, by means of communication links between the affinity websites and the electronic tip box website.

If the user's tipping account is in credit by a predetermined amount, the user is given access to a search engine by use of which the user can search, step 40, for music or songs by title or artist. Alternatively, the user may be given access to the search engine even although the user's tipping account is not sufficiently in credit to permit a download, and the user invited to increase his or her credit before any downloads take place. If the sought item is found by the search engine in a catalogue maintained by the electronic tip box website, the user is informed, step 50, that a tip is required before the song can be downloaded, or the user is informed, step 60, that a tip is requested, but is optional, before the song is downloaded or the user is informed, step 70, that the music may be downloaded without payment of a tip, but a tip may still be paid if the user desires.

In the case of the requested piece of music requiring a tip, a check is carried out, step 51, to determine whether there is more than a predetermined amount in the user's tipping account, and if not, the user is presented with the possibility of purchasing further tips, step 20, until the tip balance exceeds the predetermined minimum amount. If it is determined, in step 51, that the tipping account contains at least the predetermined amount, the user is invited, step 52, to enter a tip amount. Minimum and maximum values of the tip amount may be suggested. If the user agrees, step 53, to transfer a tip amount which is equal to or exceeds a minimum required tip for that piece of music, then the user's tipping balance is decremented by the tip amount input and a proportion of the tip received is passed to the copyright holder, step 35, and the rest of the tip received is passed to the website owner's account. An account history of the user is updated, step 80, with the transaction. The electronic file relating to the song is then downloaded over the internet to the user's terminal.

If the music item requested is marked as being one for which a tip should be requested, then a tip is requested, step 60, and it is again checked, step 61, whether the user's tipping account holds the minimum predetermined amount. If not, the user is invited to purchase further tips, step 20. If the user's tip account holds the predetermined minimum amount, then the user is invited, step 62, to enter a tip amount to be transferred from his tipping account. Minimum and maximum values of the tip amount may be suggested. A check is carried out, step 63, to determine whether a tip amount has been entered and if so, the song is downloaded, step 100, to the user's device. If a tip is not entered, the song may still be downloaded, step 100, but only after a check has been made of the account history to determine whether more than a predetermined maximum number, or percentage, of downloads have been made without payment of tips for files for which tips are requested or possibly also for files for which tips may be volunteered. Where a piece of music for which a tip is requested is downloaded without payment of a tip, an auto generate email module is updated, step 90, to indicate that the download has been made without a tip being paid. Two days later, the auto generate email module generates an email which is sent to the user to re-invite the user to pay a tip. If the tip is made, the account history is updated. If five days after the download, a tip is still not received, a further email is sent again inviting the user to pay a tip. The account history is updated with the result of that invitation.

If the music item required is an item which does not require a tip, then again the user's tipping account is checked, step 71, to determine whether credit in the tipping account exceeds a predetermined minimum, and if not, the user is invited, step 72, to purchase further tips. If the tip balance does exceed a predetermined minimum, the user is invited, step 72, to make a voluntary tip, and if a voluntary tip is made, then the tip balance is appropriately decremented and a portion of the tip passed to the copyright holder, step 35, and the remaining portion of the tip passed to the tip box website proprietor account. It is then checked, step 73, whether a voluntary tip has been paid and the account history may be updated accordingly and then the music item is downloaded, step 100.

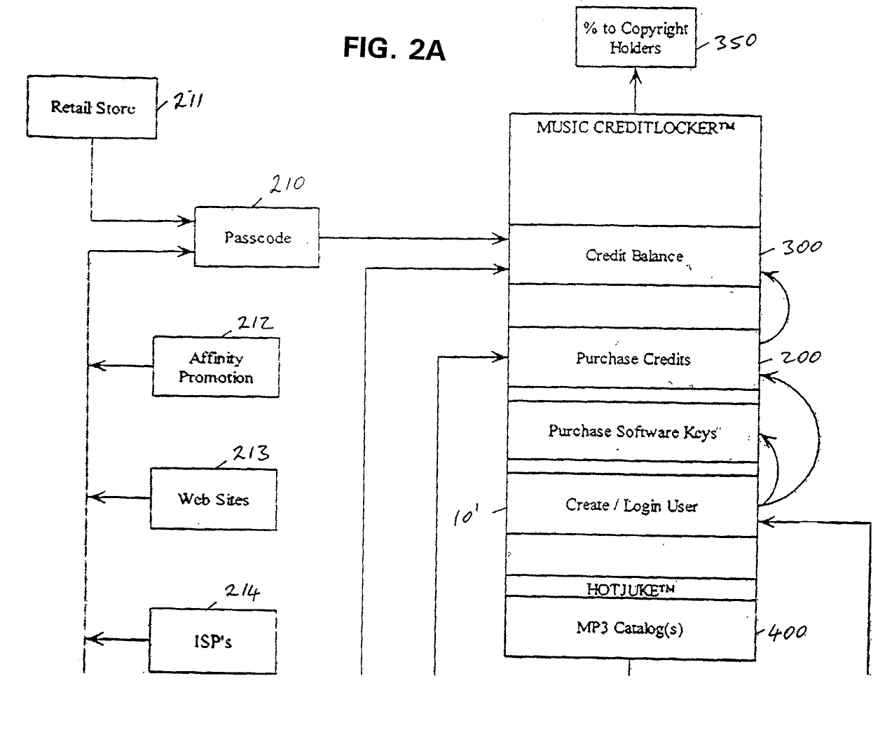

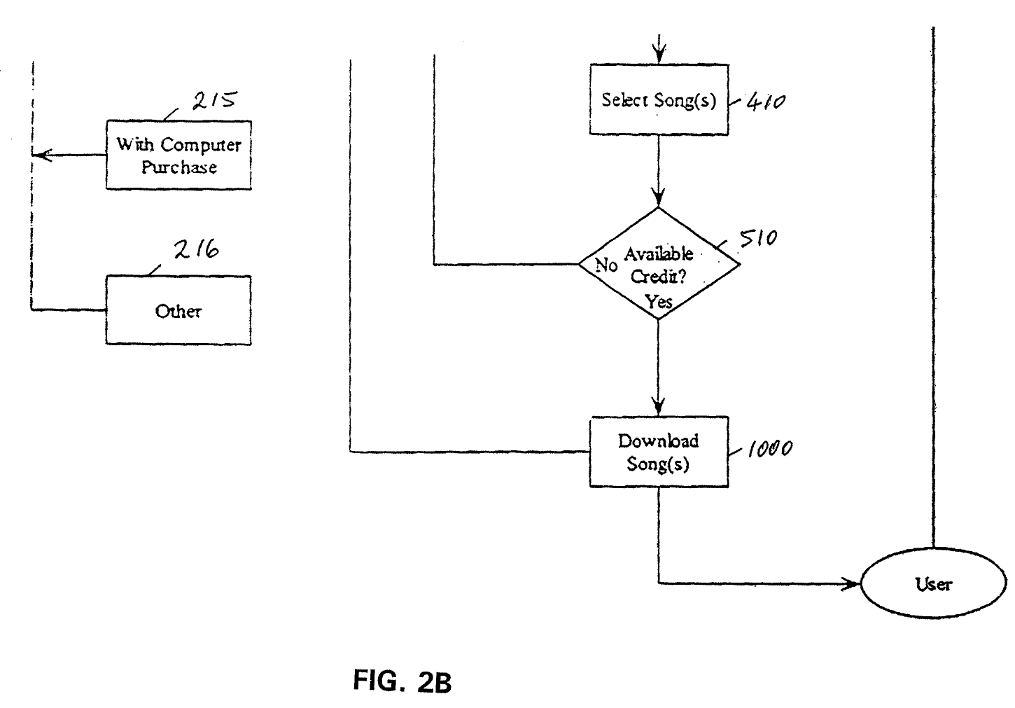

A second embodiment of the invention is illustrated in FIG. 2, in which on logging into, step 10′, a server such as a website server, a new user's account is generated for the new user and a member number and password allocated. Alternatively, an existing user may immediately enter their member number and password. The user is then invited, step 200, to purchase credits to update, step 300, a credit balance of the user.

If the credit balance then exceeds a predetermined amount, the user is then given access to a catalogue of songs or music, step 400, for searching from which the user may select, step 410, items of interest. A check is then carried out, step 510, whether the user has sufficient balance in their credit account to pay for downloads of the selected pieces of music and, if not, the user is invited, step 200, to purchase further credits to update, step 300, their credit balance further. If the user has sufficient credits, then the pieces of music are download, step 1000, and the user's credit balance is decremented by the amounts corresponding to the downloaded songs, and a proportion of the amount by which the credit amount is decremented is passed to copyright holders, step 350, and the remaining portion is passed to the website owner's account.

In addition to responding, step 200, to the invitation to purchase credits by payment, for example, by a credit card to update, step 300, the credit balance, a credit balance may also be updated by the input of, for example, a voucher number, step 210. Such vouchers may be obtained, step 211, from a retail store, or in an affinity promotion, step 212, or from another website, step 213. Alternatively, vouchers may be automatically supplied, step 214, as part of the monthly subscription to an ISP, or a number of vouchers may be supplied, step 215, on the purchase of a computer, or supplied, step 216, in some other way.

It will be understood that the credit units in the credit balance account may correspond to a maximum number of pieces of music which may be downloaded, or to a maximum play time which may be downloaded. In either case, the credit balance is updated appropriately when downloads are made. The user is informed of the remaining credit after each download and given opportunities to purchase more credits. Similarly, the status of the credit account can be checked at any time on input of the user's id and password. Facilities may be included to allow a user to listen to a piece of music before deciding whether the user wishes to download the piece of music and such access to allow a user to listen to music may be with or without a charge to the credit balance. As well as music files, the database containing these files may also contain video files and album information. The files may be checked for known viruses before downloading.

The electronic files may be encrypted to prevent further copying of the files or writing to CDs or other removable storage devices. Alternatively, the files may be encoded in such a manner that, once downloaded, only a predetermined number of copies of the downloaded file may be made, and facilities may be provided for purchasing the right to make additional copies, for example, by making further deductions from the user's tipping account and issuing a password which may be used with the encoded file to permit a predetermined number of copies to be made.

Terminals may be provided in retail outlets, such as music stores, to allow users to download files onto removable storage devices, such as CDs. In one embodiment of the invention, a user may purchase blank CDs which include, in the package, a password for downloading music files from the website and vouchers to allow, for example, four hours of downloading so that the user can build a personal album of downloaded music. Opportunities may then be given to purchase further credits.

Where musical files are grouped together in albums, limits may be placed on a number of downloads that can be made from one album.

Where vouchers are provided as part of a monthly subscription to an ISP, unused credits may be carried forward to succeeding months.

The method of the invention of downloading files has the advantage over known peer-to-peer copying of reducing, to a considerable extent, the likelihood of virus attacks. Downloading from a central fast server is also potentially considerably faster than peer-to-peer copying, where the speed of the download may be limited by the speed of the supplier's personal computer.

The invention is not limited to files of music but may also be used for electronic files of films, videos, games, photographs and textual information, for example.

It is to be understood that various modifications may be made and that all such modifications falling within the spirit and scope of the appended claims are intended to be included in the present invention.

I claim:

1. A method for a service provider to provide copies to a user of electronic files, the method comprising the steps of:
a) establishing a user's credit account for the service provider to receive advance payments from the user;
b) accepting payments into the credit account from the user;
c) providing a first catalogue of payment electronic files, a second catalogue of tipping electronic files and a third catalogue of free electronic files, to which access is to be provided;
d) receiving a request from the user for one of said payment electronic files, tipping electronic files and free electronic files;
e) confirming that the user's credit account is in credit by a predetermined minimum amount;
f) where the requested electronic file is included in the first catalogue, accepting transfer of monetary value from the user's credit account to an account of the service provider and providing a copy of the requested file, where the requested file is included in the second catalogue inviting the user to transfer a discretionary monetary value from the user's credit account to the service provider's account and providing a copy of the requested electronic file, and where the electronic file is included in the third catalogue providing a copy of the requested electronic file; and
g) transferring a proportion of the transferred monetary value, if any, to a respective copyright holder, if any, of the requested electronic file.

2. A method as claimed in claim 1, wherein where the requested electronic file is in the second catalogue, the step of inviting the user to transfer discretionary monetary value includes the further step, where the user does not transfer a discretionary monetary value, of maintaining a record of the user's access to the electronic file without paying a discretionary monetary value so that the user may subsequently be given at least one further opportunity to transfer a discretionary monetary value corresponding to the download of the said electronic file.

3. A method as claimed in claim 2, wherein where the user does not transfer monetary value on downloading the file nor in response to the at least one further opportunity, in relation to a predetermined number, or percentage, of electronic files downloaded, the user's access to electronic files in the second and third catalogues is suspended or otherwise restricted.

4. A method as claimed in claim 1, wherein the user is provided with a downloaded copy of the requested file in a protected form which limits further copying of the file to no, or a predetermined number of, further copies.

5. A method as claimed in claim 1, wherein step b) of accepting payments includes accepting a voucher number in lieu of payment to increase the credit held in the credit account.

6. A method as claimed in claim 5, wherein the voucher is distributed with one of a product and a service as a sales incentive for one of that product and service.

7. A method as claimed in claim 5, wherein the voucher permits a predetermined number of MP3 audio files to be copied.

8. A method as claimed in claim 5, wherein the voucher permits a predetermined number of minutes of MP3 audio files to be downloaded.

9. A method as claimed in claim 1, wherein at least some of the electronic files are arranged in album sets, and there is a predetermined limit on the number of files that can be copied from one album set.

10. A method as claimed in claim 1, wherein, where the requested file is included in the second catalogue, the step of inviting the user to transfer discretionary monetary value comprises requesting the user to transfer a discretionary monetary value between a predetermined minimum and a predetermined maximum amount.

11. A method as claimed in claim 1, wherein at least some of the steps of the method are carried out over a telecommunications network.

12. A method as claimed in claim 11, wherein the telecommunications network is the Internet.

13. A method as claimed in claimed 12, wherein the user's credit account is maintained on a first website and the electronic files are maintained on one or more other websites.

14. A method as claimed in claim 2, wherein a first further invitation to contribute discretionary monetary values is sent by email a first plurality of days after the file is copied and a second further invitation to transfer discretionary monetary values is sent by email a second plurality of days after the file is copied.

15. A method as claimed in claim 1, wherein a history file is maintained of records of copies of files relating to the second catalogue which are provided to a user and by reference to which further access to the method is suspended or restricted for the user when a percentage or number of copies downloaded to the user for which payment is paid falls below a predetermined percentage or number respectively.

16. A method as claimed in claim 1, wherein, where the electronic file is included in the third catalogue, the method includes the further step of accepting a voluntary transfer of monetary value from the user's credit account to the service provider's account.

17. A method as claimed in claim 1, wherein the electronic files are one or more of an audio file, a video file, a video game, a picture file or and a text file.

18. A method as claimed in claim 1, wherein, where the electronic file is included in the first catalogue, the monetary value transferred from the user's credit account is selectable by the user between a predetermined minimum amount and a predetermined maximum amount.

19. A method for a service provider to provide copies to a user of electronic files, the method comprising the steps of:
a) establishing a user's credit account for the service provider to receive advance payments from the user;
b) accepting at least one unit of credit into the credit account from the user;
c) providing a catalogue of electronic files to which access is to be provided and making the catalogue searchable by the user;
d) receiving a request from the user for one of said electronic files;
e) confirming that the user's credit account is in credit by a predetermined minimum amount;
f) transferring credit from the user's credit account to an account of the service provider, making a payment of a portion of the transferred credit to a copyright holder of the file, if any, and providing a copy of the requested file.

20. A method as claimed in claim 19, wherein the electronic file is a digital music file or a digital video file.

21. A method as claimed in claim 20, wherein the unit of credit represents an allowed predetermined playing time.

22. A method as claimed in claim 19, wherein the unit of credit represents an allowed predetermined number of downloads of electronic files.

23. A method as claimed in claim 19, wherein step f) includes the additional step of allowing the user to sample the electronic file before deciding whether to download a copy of the file.

24. A method as claimed in claim 19, wherein step b) of accepting at least one unit of credit includes the step of accepting a voucher number representing at least one unit of credit.

25. A method as claimed in claim 19, wherein step f) includes informing the user of the units of credit remaining in the user's credit account.

26. A method as claimed in claim 19, wherein the electronic files include digital music data, video data and text data.

27. A method as claimed in claim 19, wherein step f) includes providing a copy of the file encoded in such a manner to ensure that the copied file can be further copied no or only a predetermined number of times.

28. A method as claimed in claim 27, wherein step f) includes transferring further credit units from the user's credit account into an account of the service provider to permit additional copies of a file to be made.

29. A method as claimed in claim 19, wherein step d) comprises receiving a request from a user located in a retail establishment and step f) comprises providing a copy of the requested file to a terminal in the retail establishment for copying the electronic file onto a removable storage medium.
